(19) United States
(12) Patent Application Publication
(10) Pub. No.: US 2013/0073109 A1
(43) Pub. Date: Mar. 21, 2013

(54) DROOP CONTROL SYSTEM FOR GRID-CONNECTED SYNCHRONIZATION

(71) Applicants: Po-Tai CHENG, Hsinchu City (TW); Chia-Tse Lee, Tainan City (TW)

(72) Inventors: Po-Tai CHENG, Hsinchu City (TW); Chia-Tse Lee, Tainan City (TW)

(21) Appl. No.: 13/360,027

(22) Filed: Jan. 27, 2012

(30) Foreign Application Priority Data
Sep. 16, 2011 (TW) 100133300

(51) Int. Cl. G06F 1/28

(52) U.S. Cl. 700/298

(57) ABSTRACT

A droop control system for grid-connected synchronization connects to a plurality of distributed power generation modules and a utility grid system. The droop control system includes a detection processing module and a plurality of regulation control modules corresponding to the distributed power generation modules. The detection processing module is coupled with the distributed power generation modules and utility grid system in parallel to obtain a voltage difference, a phase angle difference and a frequency difference. The regulation control modules perform droop control of real power-frequency variety and reactive power-voltage variety and phase angle compensation. Through reactive power-voltage variety droop control approach, impact of impedance alterations in the power system can be eliminated and voltage fluctuations can also be minimized to achieve stable effect. Hence electric power of the utility grid system and distributed power generation modules can be regulated synchronously.

### FIELD OF THE INVENTION

The present invention relates to a grid-connected and micro grid-connected synchronization system and particularly to a droop control system for grid-connected synchronization.

### BACKGROUND OF THE INVENTION

With growing developments of renewable energy resources, a great deal of researches and developments has been devoted to the technology of distributed generation systems (DGSs) such as micro grid and smart micro grid. The power control methods applied to the micro grid system mainly can be divided into master-slave control approach and droop control approach. The master-slave control system includes multiple converters one of which is set as the primary converter and the others are secondary converters. In the event that the primary converter fails, all the secondary converters also cannot function. Moreover, as the primary converter has a load capability and voltage/current output capacity greater than that of the secondary converters, its structure has to be designed more complicated to control multiple sets of the secondary converters simultaneously. On the other hand, the droop control system to control multiple sets of converters still has a problem of voltage fluctuations caused by unmatched impedance, hence synchronization effect is undesirable.

Operation modes of the conventional grid-connected power systems generally can be divided into an islanded mode and a grid-connected mode. The islanded mode operation has not to connect to other grids, hence does not need to perform synchronization of voltage, frequency and phase. Such a mode mainly is used in a self-sufficient micro grid. In the event that the power of the power generation module in the micro grid oversupplies, the surplus of the power can be provided for a utility grid. In the event that the utility grid system is unstable, the micro grid is disconnected from the utility grid and operates independently. When the micro grid is connected to the utility grid, the grid-connected mode is formed. Since there is power exchange or supply between the micro grid and utility grid, the voltage, phase and frequency must be synchronized. The synchronization is a challenge in the grid-connected mode that is also needed to be resolved. Guerrero et al. proposed a paper of “Hierarchical Control of Droop-Controlled AC and DC Microgrids—A General Approach Toward Standardization” in IEEE Transactions on Industrial Electronics, Vol. 58, No. 1, pp. 158-172, January 2011 that discloses a droop control approach to regulate power of a micro grid. The droop control approach includes a real power-frequency method and a reactive power-voltage method, and synchronizes power voltage, phase and frequency via a multilevel control approach to solve the connection asynchronous problem among varying power systems so that the power systems can be connected in parallel or series. But synchronization via the reactive power-voltage droop control approach does not take into account of impedance alteration in the power systems. Hence power control could not rapidly minimize voltage fluctuations and achieve stable effect as desired. As a result, control of power synchronization still leaves a lot to be desired.

### SUMMARY OF THE INVENTION

The primary object of the present invention is to solve the problem of a power system that impedance alteration causes unstable voltage control.

To achieve the foregoing object, the present invention provides a droop control system for grid-connected synchronization that connects to a plurality of distributed power generation modules and a utility grid system. The droop control system includes a switch unit, a detection processing module and a plurality of regulation control modules.

The switch unit is located between the distributed power generation modules and utility grid system to control electric connecting conditions between them. The detection processing module is coupled with the distributed power generation modules and utility grid system in parallel to obtain a first electric composition and a second electric composition, and through them to further obtain a voltage difference, a phase angle difference and a frequency difference between the distributed power generation modules and utility grid system. The regulation control modules correspond to the distributed power generation modules and connect to the detection processing module, and each includes a synchronization unit to synchronize phase and a droop control unit. The synchronization unit outputs a compensation phase signal based on the phase angle difference. The droop control unit includes a real power-frequency droop controller and a reactive power-voltage variety droop controller. The real power-frequency droop controller outputs a frequency control signal based on the frequency difference. The reactive power-voltage variety droop controller outputs a voltage amplitude control signal based on the voltage amplitude variety at different times.

The distributed power generation modules perform regulation of voltage amplitude, frequency and phase according to corresponding compensation phase signal, frequency control signal and voltage amplitude control signal output from the regulation control modules, and consequently synchronize with the voltage amplitude, frequency and phase of the utility grid system, and also control the switch unit to establish electric connection between the regulation control modules and utility grid system.

By means of the technique set forth above, the invention has many features, notably:

1. Through the detection processing modules, the regulation control modules can synchronously regulate the corresponding distributed power generation modules, hence can provide synchronization control for multiple power generation modules and utility grid system.

2. Through the reactive power-voltage variety droop control approach, impact of impedance alterations in the power system can be eliminated to rapidly minimize voltage fluctuations and achieve stable effect.

3. By regulating the voltage amplitude, frequency and phase of the distributed power generation modules through the droop control unit and synchronization unit, the voltage amplitude, frequency and phase of the utility grid system can be regulated synchronously, thus they can operate steadily in the grid-connected mode.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of an embodiment of the invention.

FIG. 2 is a processing block diagram of the detection processing module of an embodiment of the invention.

FIG. 3 is a processing block diagram of the regulation control module of an embodiment of the invention.

FIG. 4 is a diagram showing reaction curves during synchronization process according to an embodiment of the invention.

### DETAILED DESCRIPTION OF THE PREFERRED EMBODIMENTS

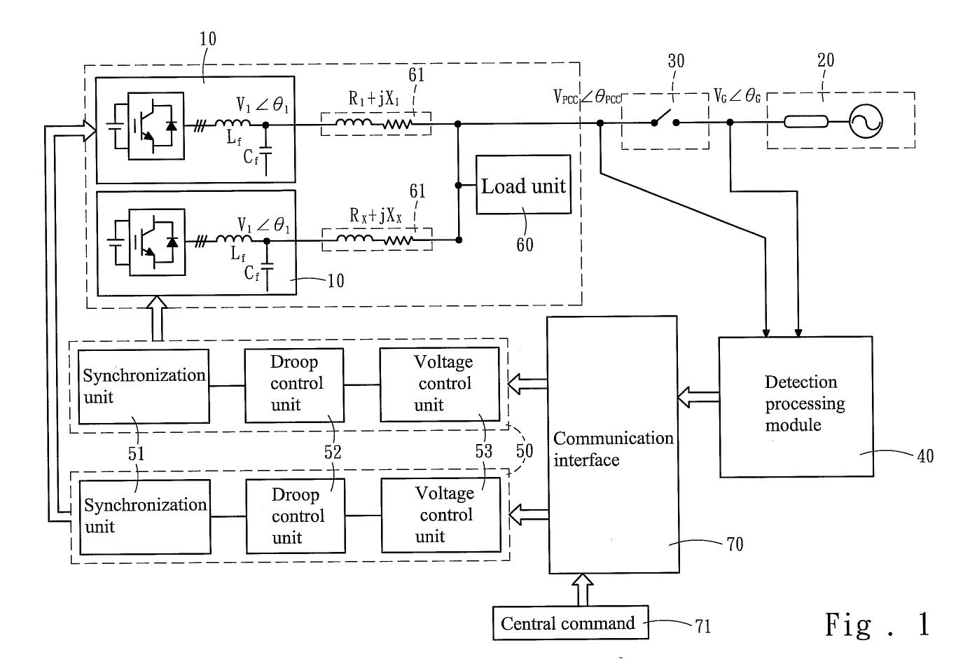

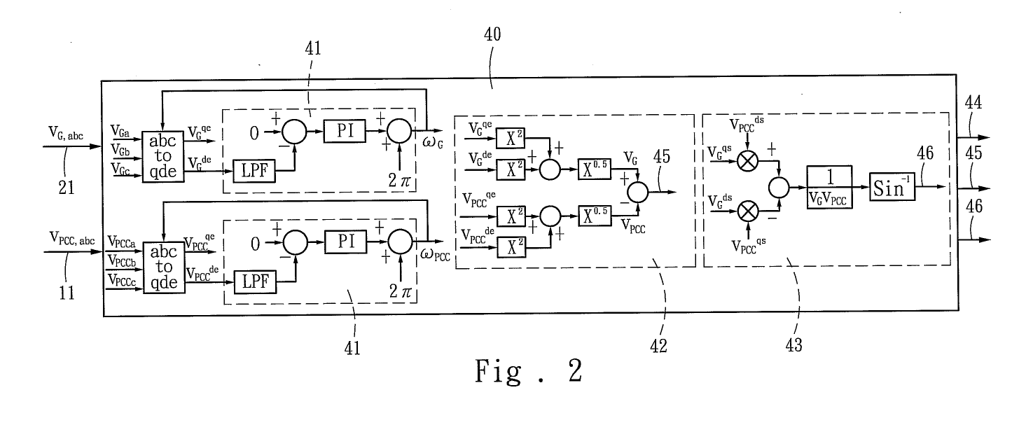

Please refer to FIGS. 1 and 2, the present invention aims to provide a droop control system for grid-connected synchronization to connect to a plurality of distributed power generation modules 10 and a utility grid system 20. The droop control system includes a switch unit 30 located between the distributed power generation modules 10 and utility grid system 20, a detection processing module 40 coupled with the distributed power generation modules 10 and utility grid system 20 in parallel, a plurality of regulation control modules 50 corresponding to the distributed power generation modules 10 and connecting to the detection processing module 40, and a load unit 60 connected to the distributed power generation modules 10 to receive electric power generated from the distributed power generation modules 10. In this embodiment, the distributed power generation modules 10 are connected to the load unit 60 via an impedance unit 61. The distributed power generation modules 10 and regulation control modules 50 can be multiple sets corresponding to each other. Two sets are provided in this embodiment to facilitate discussion. The electric power output from the distributed power generation modules 10 is denoted as VPCCΦ θPCC, while the electric power output from the utility grid system 20 is denoted as VG∠ θG, wherein θPCC and θG respectively represent the phase angle of the corresponding electric power. In addition, the detection processing module 40 is connected to the regulation control modules 50 via a communication interface 70 which transmits a central command 71 to the regulation control modules 50 to control operation thereof.

The switch unit 30 controls electric connecting conditions of the distributed power generation modules 10 and utility grid system 20. In the event that the switch unit 30 is disconnected to break off the electric connection between the distributed power generation modules 10 and utility grid system 20, an islanded mode is formed. In the event that the distributed power generation modules 10 directly provide electric power to the load unit 60, and the switch unit 30 forms electric connection between the distributed power generation modules 10 and utility grid system 20, a grid-connected mode is formed. In the grid-connected mode, electric power of the load unit 60 is provided both from the distributed power generation modules 10 and utility grid system 20. Or the distributed power generation modules 10 not only supply electric power for the load unit 60, but also provide electric power to the utility grid system 20.

The detection processing module 40 obtains a first electric composition 11 from the distributed power generation modules 10 and a second electric composition 21 from the utility grid system 20, and through the first electric composition 11 and second electric composition 21 further obtains a voltage difference 45, a phase angle difference 46 and a frequency difference 44 between the distributed power generation modules 10 and utility grid system 20. Please refer to FIG. 2 for the detection processing module in an operating condition. After the first electric composition 11 and second electric composition 21 are obtained, they are transmitted to a phase lock loop 41 to obtain the frequency difference 44, and further transmitted to a voltage amplitude difference processing unit 42 to obtain the voltage difference 45, and to a phase angle difference processing unit 43 to obtain the phase angle difference 46. More specifically, the first electric composition 11 and second electric composition 21 have respectively three phases of abc which are denoted as VGa, VGb, VGc, VPCCa, VPCCb and VPCCc, and these six phases are then converted to four phases of qde for following processes that are denoted as VGqe, VGde, VPCCqe and VPCCde. Through a low pass filter (LPF) and a proportional and integration controller (PI) in the phase lock loop 41 to perform conversion and obtain corresponding frequency and angular velocity (ωG and ωPCC). Through the voltage amplitude difference processing unit 42, a positive voltage difference 45 is obtained from a square root. The phase angle difference 46 is obtained through formula (1) via the corresponding phase angle difference processing unit 43 shown in FIG. 2, and formula (1) is expressed as follows:

$$[ \begin{matrix}{V}_{G}^{qs} \\ {V}_{G}^{ds}\end{matrix} ] = [ \begin{matrix}{V}_{G} cos ( {ω}_{G} \times t + {θ}_{G} ) \\ - {V}_{G} sin ( {ω}_{G} \times t + {θ}_{G} )\end{matrix} ] \\ [ \begin{matrix}{V}_{PCC}^{qs} \\ {V}_{PCC}^{ds}\end{matrix} ] = [ \begin{matrix}{V}_{PCC} cos ( {ω}_{PCC} \times t + {θ}_{PCC} ) \\ - {V}_{PCC} sin ( {ω}_{PCC} \times t + {θ}_{PCC} )\end{matrix} ] \\ \begin{matrix}{θ}_{diff} = {sin}^{- 1} [ \frac{1}{{V}_{G} {V}_{PCC}} ( {V}_{G}^{qs} \times {V}_{PCC}^{ds} - {V}_{G}^{ds} \times {V}_{PCC}^{qs} ) ] \\ = ( {ω}_{G} - {ω}_{PCC} ) \times t + ( {θ}_{G} - {θ}_{PCC} )\end{matrix} \qquad ( 1 )$$

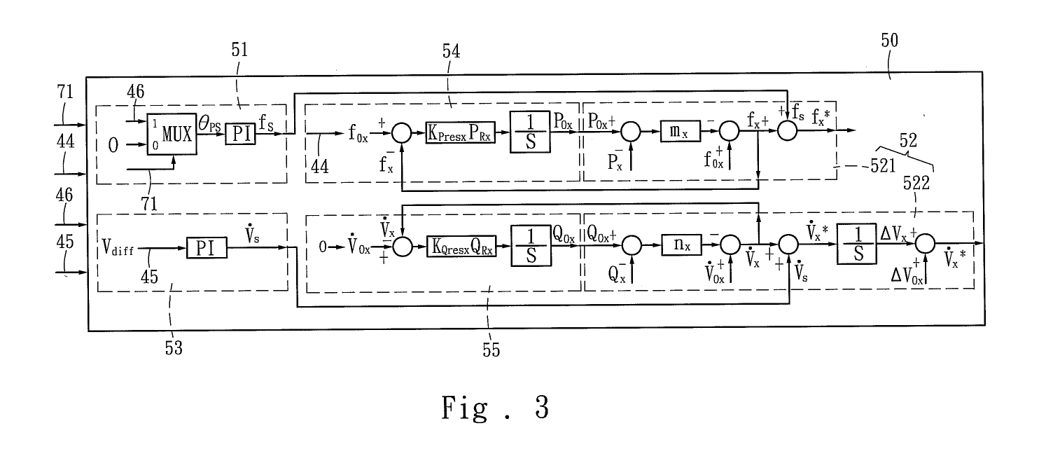

Also referring to FIG. 3, each regulation control module 50 includes a synchronization unit 51 to synchronize phase angles, a droop control unit 52 and a voltage control unit 53. The voltage control unit 53 is connected to the detection processing module 40 and droop control unit 52, and regulates voltage and outputs to the droop control unit 52 based on the voltage difference 45. The droop control unit 52 includes a real power-frequency droop controller (P-f droop controller) 521 and a reactive power-voltage variety droop controller (Q-V droop controller) 522. It is to be noted that the voltage variety means voltage amplitude alterations at different times. Hence V is used to indicate the voltage amplitude alterations that is different from the voltage V. The P-f droop controller 521 outputs a frequency control signal f*ₓ based on the frequency difference 44. The P-f droop controller 521 also is connected to a frequency restoration 54 which receives a signal via feedback from the P-f droop controller 521 to perform feedback regulation, and outputs a real power set point P₀ₓ for real power regulation to the P-f droop controller 521. The Q-V droop controller 522 outputs a voltage amplitude control signal \dot{V}*ₓ based on the voltage amplitude variety at different times. The Q-V droop controller 522 is connected to a voltage restoration 55 which receives a signal via feedback from the Q-V droop controller 522 to perform feedback regulation and regulate and output a reactive power set point output to the Q-V droop controller 522.

The control signals output from the P-f droop controller 521 and Q-V droop controller 522 can be obtained through the following formulas (2) and (3):

$$\begin{matrix}{f}_{x}^{*} = {f}_{0 x} - {m}_{x} \cdot ( {P}_{0 x} - {P}_{x} ) + {f}_{s} \\ {\dot{V}}_{x}^{*} = {\dot{V}}_{0 x} - {n}_{x} \cdot ( {Q}_{0 x} - {Q}_{x} ) + {\dot{V}}_{s} \\ {V}_{x}^{*} = {V}_{0 x} + \int {\dot{V}}_{x}^{*} d t & ( 2 ) \\ \frac{d}{d t} {P}_{0 x} = {K}_{Presx} {P}_{Rx} ( {f}_{0 x} - {f}_{x} ) \\ \frac{d}{d t} {Q}_{0 x} = {K}_{Qresx} {Q}_{Rx} ( {\dot{V}}_{0 x} - {\dot{V}}_{x} ) & ( 3 )\end{matrix}$$

wherein mₓ and nₓ are droop coefficients of the real power and reactive power, and f₀ₓ, \dot{V}₀ₓ and V₀ₓ represent respectively norminal frequency, nominal voltage amplitude variety and norminal voltage magnitude. P₀ₓ and Q₀ₓ represent respectively real power set point and reactive power set point that relate to electric power storage amount of the distributed power generation modules 10.

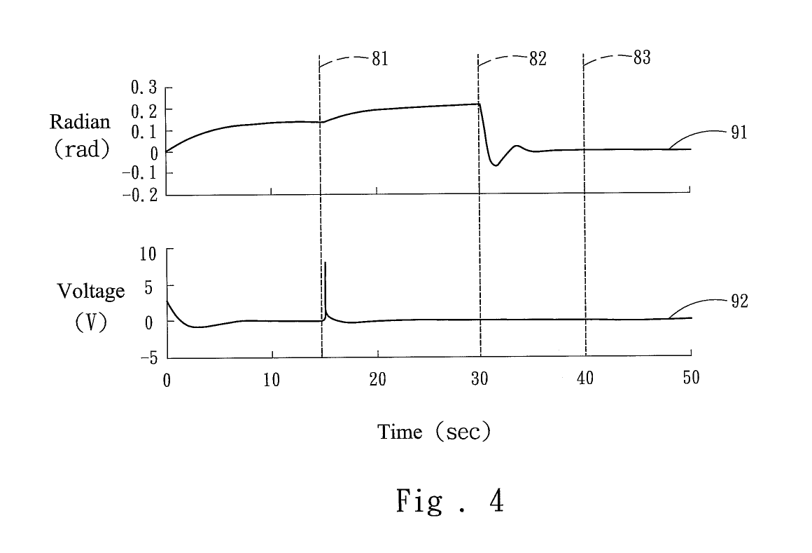

In the aforesaid formula (2), \dot{V}₀ₓ is generally set 0, which indicates no voltage amplitude variety. Q₀ₓ represents the reactive power set point at the beginning. Based on this, integral value of the voltage amplitude at different times can be obtained to determine regulation of parameters for droop control. The P-f droop controller 521 can only regulate the frequency difference 44 to allow the power frequency output from the distributed power generation modules 10 to be the same as that of the utility grid system 20. But the original existing phase angle difference 46 or the phase angle difference 46 generated during regulation period cannot be compensated via frequency synchronization. The synchronization unit 51 outputs a phase angle compensation signal based on the phase angle difference 46, thus the power phase angle output from the distributed power generation modules 10 synchronizes with that of the utility grid system 20. In the invention, the central command 71 controls the synchronization unit 51 to issue the phase angle compensation signal at desired time to compensate the phase angle, which is expressed by formulas (4) and (5) as follows:

$$\begin{matrix}{\dot{V}}_{S} = {K}_{vp} \cdot {V}_{diff} + {k}_{vi} \int {V}_{diff} d t & ( 4 ) \\ {f}_{S} = {K}_{pp} \cdot {θ}_{PS} + {k}_{pi} \int {θ}_{PS} d t \\ {θ}_{PS} \{ \begin{matrix}{θ}_{diff} & if GS = 1 \\ 0 & if GS = 0\end{matrix} & ( 5 )\end{matrix}$$

wherein GS represents the central command; when it is 1, phase compensation is performed; when it is 0, no compensation is performed. The invention performs synchronization as follows: when the switch unit 30 is OFF and in the islanded mode, the detection processing module 40 obtains the first electric composition 11 from the distributed power generation modules 10 and second electric composition 21 from the utility grid system 20, and then the voltage difference 45, phase angle difference 46 and frequency difference 44 are obtained through calculation; next, the regulation control module 50 performs voltage compensation and frequency compensation. Also referring to FIG. 4 for three display conditions which include a time point of altering load 81, a time point of compensating phase angle 82 and a time point of switching ON 83. In this embodiment, at the time point of altering load 81, the amount of the load is changed to observe synchronization condition. Hence before the time point of altering load 81, the phase angle variety curve 91 gradually becomes flat because of frequency regulation, and also becomes more stable. The voltage variety curve 92 also approaches 0 coinciding with the voltage difference 45 through voltage regulation performed by the regulation control module 50. After the time point of altering load 81, the voltage variety curve 92 increases instantly that represents change of the voltage difference 45 caused by load alteration. But through the immediate regulation of the regulation control module 50, the voltage difference 45 returns to 0. Meanwhile, the frequency also changes, and the phase angle changes accordingly shown by the phase angle variety curve 91. After a period of time, although the variety of the phase angle gradually becomes stable, the phase angle difference still exists between the distributed power generation modules 10 and the utility grid system 20. At the time point of compensating phase angle 82, referring to FIG. 3, the central command 71 controls the synchronization unit 51 to output the phase angle compensation signal to compensate the phase angle difference 46 to become 0, thus the distributed power generation modules 10 and utility grid system 20 can be synchronized. At the time point of switching ON 83, the switch unit 30 is ON to form electric connection between the distributed power generation modules 10 and utility grid system 20 to enter the micro-grid mode to perform electric power exchange.

As a conclusion, the invention provides multiple detection processing modules 40 to allow multiple regulation control modules 50 to perform synchronization for multiple distributed power generation modules 10, and can be used for system synchronization control of the distributed power generation modules and utility grid system. Moreover, through the reactive power-voltage variety droop control approach, impact of impedance alterations in the power system can be eliminated, and rapidly minimize voltage fluctuations to achieve stable effect. Finally, by regulating the voltage amplitude, frequency and phase angle of the distributed power generation modules 10 via the droop control unit 52 and synchronization unit 51, they can be synchronized with the voltage amplitude, frequency and phase angle of the utility grid system 20 to stably operate in the grid-connected mode. It provides significant improvements over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A droop control system for grid-connected synchronization to connect to a plurality of distributed power generation modules and a utility grid system, comprising:
a switch unit located between the plurality of distributed power generation modules and the utility grid system to control electric connecting conditions between them;
a detection processing module coupled with the distributed power generation modules and the utility grid system in parallel to obtain respectively therefrom a first electric composition and a second electric composition to further acquire a voltage difference, a phase angle difference and a frequency difference between the distributed power generation modules and the utility grid system; and
a plurality of regulation control modules connected to the distributed power generation modules and the detection processing module, each of the plurality of regulation control module including a synchronization unit to synchronize phases and a droop control unit, the synchronization unit outputting a compensation phase signal based on the phase angle difference, the droop control unit including a real power-frequency droop controller to output a frequency control signal based on the frequency difference and a reactive power-voltage variety droop controller to output a voltage amplitude control signal based on voltage amplitude variety at different times;
wherein the distributed power generation modules perform regulation of voltage amplitude, frequency and phase based on the compensation phase signal, the frequency control signal and the voltage amplitude control signal output from the plurality of regulation control modules to allow the voltage amplitude, the frequency and the phase to be synchronized with voltage amplitude, frequency and phase of the utility grid system, and control the switch unit to form electric connection between the regulation control modules and the utility grid system.

2. The droop control system for grid-connected synchronization of claim 1, wherein the regulation control module further includes a voltage control unit connected to the detection processing module and the droop control unit to regulate voltage based on the voltage difference and output the voltage to the droop control unit.

3. The droop control system for grid-connected synchronization of claim 1, wherein the regulation control module further includes a frequency restoration connected to the real power-frequency droop controller to regulate a real power set point output to the real power-frequency droop controller.

4. The droop control system for grid-connected synchronization of claim 1, wherein the regulation control module further includes a voltage variety restoration connected to the reactive power-voltage variety droop controller to regulate a reactive power set point output to the reactive power-voltage variety droop controller.

5. The droop control system for grid-connected synchronization of claim 1 further including a load unit connected to the distributed power generation modules to receive electric power generated by the distributed power generation modules.

6. The droop control system for grid-connected synchronization of claim 5, wherein the distributed power generation modules are respectively connected to the load unit via an impedance unit.

7. The droop control system for grid-connected synchronization of claim 1, wherein the detection processing module is connected to the regulation control modules through a communication interface.

8. The droop control system for grid-connected synchronization of claim 7, wherein through the communication interface, a central command is transmitted to the synchronization unit to control the synchronization unit to output the compensation phase signal.
